(19) United States
(12) Patent Application Publication
(10) Pub. No.: US 2026/0101309 A1
(43) Pub. Date: Apr. 9, 2026

(54) METHOD AND DEVICE FOR PREDICTING LOCATION USING ULTRA-WIDEBAND COMMUNICATION SIGNAL

(71) Applicant: Samsung Electronics Co., Ltd., Gyeonggi-do (KR)

(72) Inventors: Junyoung CHOI, Gyeonggi-do (KR); Sagnik BHATTACHARYA, Gyeonggi-do (KR)

(21) Appl. No.: 19/114,230

(22) PCT Filed: Oct. 13, 2022
(86) PCT No.: PCT/KR2022/015536

§ 371 Date: Mar. 21, 2025

(51) Int. Cl. H04W 64/00; H04B 1/7163; H04L 41/16

(52) U.S. Cl. CPC H04W 64/00; H04B 1/7163; H04L 41/16

(57) ABSTRACT

Disclosed is a method by which an electronic device predicts the location of a UWB signal. The method of the present disclosure may comprise the steps of: generating an input sequence from input data for a preset number of timesteps; generating an output sequence including prediction data for a next timestep from the input sequence using a trained RNN-based model; and obtaining information about a predicted location of the electronic device at the next timestep on the basis of the prediction data in the output sequence. The input data may include UWB DL-TDoA data.

### TECHNICAL FIELD

The disclosure relates to a method and device for predicting location using a UWB signal.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for: sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

### DETAILED DESCRIPTION OF THE INVENTION

### Technical Problem

The disclosure provides a method for predicting location by a model trained based on UWB data.

### Technical Solution

According to various embodiments of the disclosure, a method by an electronic device using ultra-wideband (UWB) communication may comprise generating an input sequence from input data for a preset number of timesteps, the input data including UWB downlink time difference of arrival (DL-TDoA) data, generating an output sequence including prediction data for a next timestep from the input sequence using a trained recurrent neural network (RNN)-based model, and obtaining information about a predicted location of the electronic device at the next timestep based on the prediction data in the output sequence.

According to various embodiments of the disclosure, an electronic device using ultra-wideband (UWB) communication may comprise a transceiver and a controller connected to the transceiver. The controller may be configured to generate an input sequence from input data for a preset number of timesteps, the input data including UWB downlink time difference of arrival (DL-TDoA) data, generate an output sequence including prediction data for a next timestep from the input sequence using a trained recurrent neural network (RNN)-based model, and obtain information about a predicted location of the electronic device at the next timestep based on the prediction data in the output sequence.

### BRIEF DESCRIPTION OF DRAWINGS

FIG. 1 is a block diagram schematically illustrating an electronic device:

FIG. 2A illustrates an example architecture of a UWB device according to an embodiment of the disclosure:

FIG. 2B illustrates an example configuration of a framework of a UWB device according to an embodiment of the disclosure;

FIG. 3A illustrates a structure of a UWB MAC frame according to an embodiment of the disclosure;

FIG. 3B illustrates a structure of a UWB PHY packet according to an embodiment of the disclosure;

FIG. 4 illustrates an example of a structure of a ranging block and round used for UWB ranging according to an embodiment of the disclosure;

FIG. 5A illustrates a method for a UWB device to perform UWB ranging in a DL-TDoA scheme according to an embodiment of the disclosure;

FIG. 5B illustrates an example of a ranging block structure for a downlink TDoA scheme according to an embodiment of the disclosure;

FIG. 6 illustrates a scenario for DL-TDoA-based positioning according to an embodiment of the disclosure;

FIG. 7 illustrates a system model for predicting location according to an embodiment of the disclosure;

FIG. 8 illustrates a configuration of a user device for predicting location according to an embodiment of the disclosure;

FIG. 9 illustrates a test environment for evaluating the performance of a location estimation method according to an embodiment of the disclosure;

FIGS. 10A and 10B illustrate a performance evaluation result in a first scenario according to an embodiment of the disclosure;

FIGS. 11A and 11B illustrate a performance evaluation result in a second scenario according to an embodiment of the disclosure;

FIGS. 12A and 12B illustrate a performance evaluation result in a third scenario according to an embodiment of the disclosure;

FIG. 13 illustrates a method for predicting location using a trained model by an electronic device according to an embodiment of the disclosure; and

FIG. 14 is a view illustrating a structure of an electronic device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative location estimation based on the distance between two devices or accurate location estimation of a device based on the distance from fixed devices (whose locations are known).

The terminology used herein is provided for a better understanding of the disclosure, and changes may be made thereto without departing from the technical spirit of the disclosure.

“Application dedicated file (ADF)” may be, e.g., a data structure in an application data structure that may host an application or application specific data.

“Application protocol data unit (APDU)” may be a command and a response used when communicating with the application data structure in the UWB device.

“Application specific data” may be, e.g., a file structure having a root level and an application level including UWB controlee information and UWB session data required for a UWB session.

“Controller” may be a ranging device that defines and controls ranging control messages (RCM) (or control messages). The controller may define and control ranging features by transmitting a control message.

“Controlee” may be a ranging device using a ranging parameter in the RCM (or control message) received from the controller. The controlee may use the same ranging features as those configured through control messages from the controller.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Applet” may be, e.g., an applet executed on the secure component including UWB parameters and service data. The applet may be a FiRa applet.

“Ranging device” may be a device capable of performing UWB ranging. In the disclosure, the ranging device may be an enhanced ranging device (ERDEV) defined in IEEE 802.15.4z or a FiRa Device. The ranging device may be referred to as a UWB device.

“UWB-enabled Application” may be an application for UWB service. For example, the UWB-enabled Application may be an application using a Framework API for configuring an OOB Connector, a Secure Service, and/or a UWB service for a UWB session. “UWB-enabled Application” may be abbreviated as an application or a UWB application. UWB-enabled Application may be a FiRa-enabled Application.

“Framework” may be a component that provides access to Profiles, individual-UWB configuration and/or notifications. “Framework” may be, e.g., a collection of logical software components including Profile Manager, OOB Connector, Secure Service, and/or UWB service. The framework may be a FiRa framework.

“OOB Connector” may be a software component for establishing an out-of-band (OOB) connection (e.g., BLE connection) between Ranging Devices. The OOB connector may be a FiRa OOB connector.

“Profile” may be a previously defined set of UWB and OOB configuration parameters. The profile may be a FiRa profile.

“Profile Manager” may be a software component that implements a profile available on the Ranging Device. The profile manager may be a FiRa profile manager.

“Service” may be an implementation of a use case that provides a service to an end-user.

“Smart Ranging Device” may be a ranging device that may implement an optional Framework API. The smart ranging device may be a FiRa smart device.

“Global Dedicated File (GDF)” may be a root level of application specific data including data required to establish a USB session.

“Framework API” may be an API used by a UWB-enabled Application to communicate with the Framework.

“Initiator” may be a Ranging Device that initiates a ranging exchange. The initiator may initiate a ranging exchange by transmitting a first RFRAME (ranging exchange message).

“Object Identifier (OID)” may be an identifier of the ADF in the application data structure.

“Out-Of-Band (OOB)” may be data communication that does not use UWB as an underlying wireless technology.

“Ranging Data Set (RDS)” may be data (e.g., UWB session key, session ID, etc.) required to establish a UWB session when it is needed to protect confidentiality, authenticity and integrity.

“Responder” may be a ranging device that responds to the Initiator in a ranging exchange. The responder may respond to the ranging exchange message received from the initiator.

“STS” may be a ciphered sequence for increasing the integrity and accuracy of ranging measurement timestamps. The STS may be generated from the ranging session key.

“Secure channel” may be a data channel that prevents overhearing and tampering.

“Secure component” may be an entity (e.g., secure element (SE) or trusted execution environment (TEE)) having a defined security level that interfaces with UWBS for the purpose of providing RDS to UWBS, e.g., when dynamic STS is used.

“SE” may be a tamper-resistant secure hardware component that may be used as a Secure Component in the Ranging Device.

“Secure ranging” may be ranging based on STS generated through a strong encryption operation.

“Secure Service” may be a software component for interfacing with a Secure Component, such as a Secure Element or TEE.

“Service Applet” may be an applet on a Secure Component that handles service specific transactions.

“Service Data” may be data defined by a service provider that needs to be transferred between two ranging devices to implement a service.

“Service Provider” may be an entity that defines and provides hardware and software required to provide a specific service to an end-user.

“Static STS mode” is an operation mode in which STS is repeated during a session, and does not need to be managed by the Secure Component.

“Secure UWB Service (SUS) Applet” may be an applet on the SE that communicates with the applet to retrieve data needed to enable secure UWB sessions with other ranging devices. The SUS Applet may transfer corresponding data (information) to the UWBS.

“UWB Service” may be a software component that provides access to the UWBS.

“UWB Session” may be a period from when the Controller and the Controlee start communication through UWB until the communication stops. A UWB Session may include ranging, data transfer, or both ranging and data transfer.

“UWB Session ID” may be an ID (e.g., a 32-bit integer) that identifies the UWB Session, shared between the controller and the controller.

“UWB session key” may be a key used to protect the UWB Session. The UWB Session Key may be used to generate the STS. The UWB session key may be a UWB ranging session key (URSK), and may be abbreviated as a session key.

“UWB Subsystem (UWBS)” may be a hardware component implementing the UWB PHY and MAC layers specifications. UWBS may have an interface to Framework and an interface to Secure Component to search for RDS.

“UWB message” may be a message including a payload IE transmitted by the UWB device (e.g., ERDEV). The UWB message may be such a message as, e.g., ranging initiation message (RIM), ranging response message (RRM), ranging final message (RFM), control message (CM), measurement report message (MRM), ranging result report message (RRRM), control update message (CUM) or one-way ranging (OWR) message. If necessary, a plurality of messages may be merged into one message.

“OWR” may be a ranging scheme using messages unilaterally transmitted between a ranging device and one or more other ranging devices. OWR may be used to measure the time difference of arrival (TDoA). Additionally, OWR may be used to measure AoA at the receiving end, rather than measuring TDoA. In this case, a pair of advertiser and observer may be used.

“TWR” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. For example, SS-TWR may include a RIM transmission operation from the initiator to the responder, and an RRM transmission operation from the responder to the initiator. DS-TWR may be a procedure for performing ranging through two round-trip time measurements. For example, DS-TWR may include a RIM transmission operation from the initiator to the responder, an RRM transmission operation from the responder to the initiator, and an RFM transmission operation from the initiator to the responder. Through the ranging exchange, the time of flight (ToF) may be calculated, and the distance between the two devices may be estimated. Meanwhile, during the TWR process, the measured AoA information (e.g., AoA azimuth result, AoA elevation result) may be transferred to another ranging device through RRRM or other messages. In the disclosure, TWR may also be referred to as UWB TWR.

“DL-TDoA” may be called Downlink Time Difference of Arrival (DL-TDoA), reverse TDoA, and its default operation may be for the user equipment (UE) (tag device) to overhear (or receive) the message of the anchor device while a plurality of anchor devices broadcast or exchange messages. DL-TDoA may be classified as a type of one way ranging like Uplink TDoA. The UE performing the DL-TDoA operation may overhear the messages transmitted by the two anchor devices to calculate a TDoA proportional to the difference between the distances between each anchor device and the UE. The UE may calculate a relative distance to the anchor device by using TDoA with several pairs of anchor devices and use it for positioning. The operation of the anchor device for DL-TDoA may be similar to that of, e.g., DS-TWR defined in IEEE 802.15.4z and may further include other useful time information so that the UE may calculate the TDoA. DL-TDoA may be referred to as DL-TDoA localization.

“Anchor device” may be referred to as an anchor, a UWB anchor or a UWB anchor device and may be a UWB device deployed in a specific location to provide a positioning service. For example, the anchor device may be a UWB device installed by a service provider on a wall, ceiling, structure, or the like in a room to provide an indoor positioning service. Anchor devices may be divided into initiator anchors and responder anchors according to the order and role of transmitting messages.

“Initiator anchor” may be referred to as an initiator UWB anchor, an initiator anchor device, or the like and may announce the start of a specific ranging round. The initiator anchor may schedule a ranging slot for the responder anchors operating in the same ranging round to respond. The initiation message of the initiator anchor may be referred to as an initiator Downlink TDoA Message (DTM) or Poll message. The initiation message of the initiator anchor may include a transmission timestamp. The initiator anchor may additionally transfer an end message after receiving responses from the responder anchors. The end message of the initiator anchor may be referred to as Final DTM or Final message. The end message may include the time of the reply to the messages sent by the responder anchors. The end message may include a transmission timestamp.

“Responder anchor” may also be referred to as a Responder UWB anchor, a Responder UWB anchor device, a Responder anchor device, etc. The responder anchor may be a UWB anchor responding to the initiation message of the initiator anchor. The message with which the responder anchor responds may include the time of reply to the initiation message. The message with which the responder anchor responds may be referred to as a Responder DTM or a Response message. The response message of the responder anchor may include a transmission timestamp.

The “tag device” may estimate its location (e.g., geographical coordinates) by using TDoA measurement based on the DTM received from the anchor device in DL-TDoA. The tag device may previously know the location of the anchor device. The tag device may be referred to as a UWB tag, user equipment (UE), or UWB tag device, and the DL-TDoA tag device may be referred to as a DL-TDoA tag or a DT-tag. The tag device may receive the message transmitted by the anchor device and measure the reception time of the message. The tag device may obtain the geographic coordinates of the anchor device through an in-band or out-band method. The tag device may skip the ranging block when the location update rate is lower than that supported by the network.

“Cluster” may mean a set of UWB anchors covering a specific area. The cluster may be composed of an initiator UWB anchor and responder UWB anchors responding thereto. For 2D positioning, one initiator UWB anchor and at least three responder UWB anchors may be typically required and, for 3D positioning, one initiator UWB anchor and at least four responder UWB anchors may be required. If the initiator UWB anchor and the responder UWB anchor may be accurately time-synchronized through a separate wired/wireless connection, one initiator UWB anchor and two responder UWB anchors may be required for 2D positioning, and one initiator UWB anchor and three responder UWB anchors may be required for 3D positioning. Unless otherwise stated, it is assumed that there is no separate device for wired/wireless time synchronization between UWB anchors. The cluster area may be a space formed by the UWB anchors constituting the cluster. To support the positioning service for a wide area, a plurality of clusters may be configured to provide the positioning service to the UE. Cluster may be referred to as a cell. The operation of the cluster may be understood as the operation of anchor(s) belonging to the cluster.

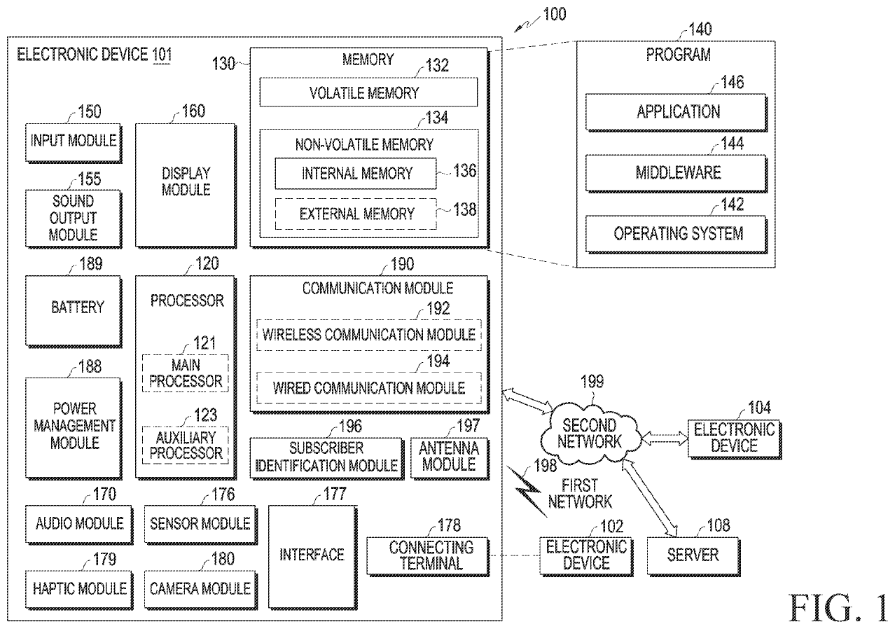

FIG. 1 is a block diagram schematically illustrating an electronic device.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C.” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic.” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

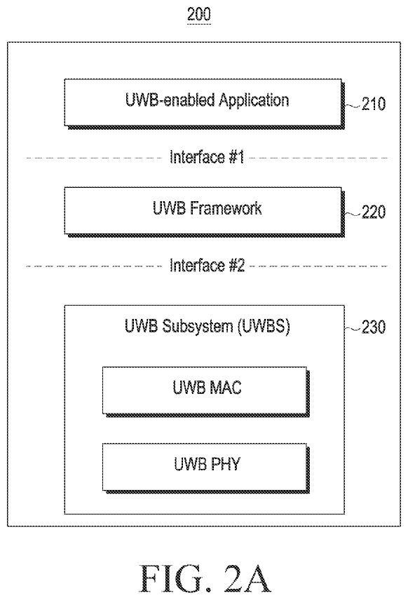

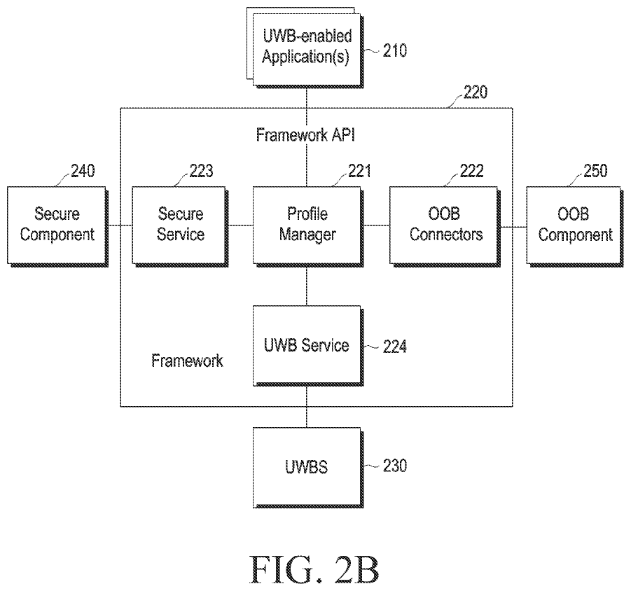

FIG. 2A illustrates an example architecture of a UWB device according to an embodiment of the disclosure.

In the disclosure, the UWB device 200 may be an electronic device supporting UWB communication. For example, the UWB device 200 may be an example of the electronic device 101 of FIG. 1.

The UWB device 200 may be, e.g., a ranging device supporting UWB ranging. In an embodiment, the ranging device may be an enhanced ranging device (ERDEV) or a FiRa device.

In the embodiment of FIG. 2A, the UWB device 200 may interact with other UWB devices through a UWB session.

The UWB device 200 may implement a first interface (Interface #1) that is an interface between the UWB-enabled Application 210 and the Framework 220, and the first interface allows the UWB-enabled application 110 on the UWB device 200 to use the UWB capabilities of the UWB device 200 in a predetermined manner. In an embodiment, the first interface may be a Framework API or a proprietary interface, but is not limited thereto.

The UWB device 200 may implement a second interface (Interface #2) that is an interface between the UWB Framework 210 and the UWB subsystem (UWBS, 230). In an embodiment, the second interface may be a UWB Command Interface (UCI) or proprietary interface, but is not limited thereto.

Referring to FIG. 2A, the UWB device 200 may include a UWB-enabled Application 210, a Framework (UWB Framework) 220, and/or a UWBS 230 including a UWB MAC Layer and a UWB Physical Layer. Depending on the embodiment, some entities may not be included in the UWB device, or additional entities (e.g., security layer) may be further included.

The UWB-enabled Application 210 may trigger establishment of a UWB session by a UWBS 230 through the first interface. The UWB-enabled Application 210 may use one of previously defined profiles (profile). For example, the UWB-enabled Application 210 may use one of the profiles defined in FiRa or a custom profile. The UWB-enabled Application 210 may use the first interface to handle related events, such as service discovery, ranging notifications, and/or error conditions.

The Framework 220 may provide access to Profiles, individual-UWB configuration and/or notifications. The Framework 220 may support at least one of a function for UWB ranging and transaction execution, a function to provide an interface to the application and UWBS 230, or a function to estimate the location of the device 200. The Framework 220 may be a set of software components. As described above, the UWB-enabled Application 210 may interface with the Framework 220 through the first interface, and the Framework 220 may interface with the UWBS 230 through the second interface.

Meanwhile, in the disclosure, the UWB-enabled Application 210 and/or Framework 220 may be implemented by an application processor (AP) (or processor). Accordingly, in the disclosure, the operation of the UWB-enabled Application 210 and/or the Framework 220 may be understood as performed by an AP (or a processor). In this disclosure, the framework may be referred to as an AP or a processor.

The UWBS 230 may be a hardware component including a UWB MAC Layer and a UWB Physical Layer. The UWBS 230 may perform UWB session management and may communicate with the UWBS of another UWB device. The UWBS 230 may interface with the Framework 120 through the second interface and may obtain the secure data from the Secure Component. In an embodiment, the Framework (or application processor) 220 may transmit a command to the UWBS 230 through UCI, and the UWBS 230 may transmit a response to the command to the Framework 220. The UWBS 230 may transfer a notification to the Framework 120 through the UCI.

FIG. 2B illustrates an example configuration of a framework of a UWB device according to an embodiment of the disclosure.

The UWB device of FIG. 2B may be an example of the UWB device of FIG. 2A.

Referring to FIG. 2B, the Framework 220 may include. e.g., software components, such as Profile Manager 221, OOB Connector(s) 222, Secure Service 223 and/or UWB service 224.

The Profile Manager 221 may serve to manage profiles available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The UWB-enabled Application 210 may communicate with the Profile Manager 221 through the first interface (e.g., Framework (API)).

The OOB Connector 222 may serve to establish an OOB connection with another device. The OOB Connector 222 may handle an OOB step including a discovery step and/or a connection step. The OOB component (e.g., BLE component) 250 may be connected to the OOB connector 222.

The Secure Service 223 may play a role of interfacing with a Secure Component 240, such as SE or TEE.

The UWB Service 224 may perform a role of managing the UWBS 230. The UWB Service 224 may provide access to the UWBS 230 from the Profile Manager 221 by implementing the second interface.

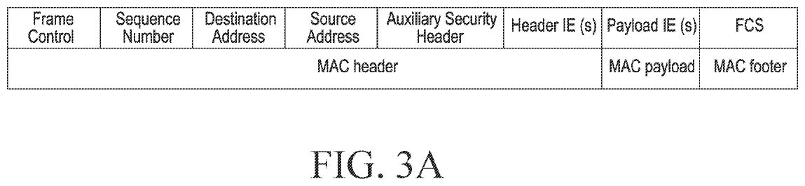

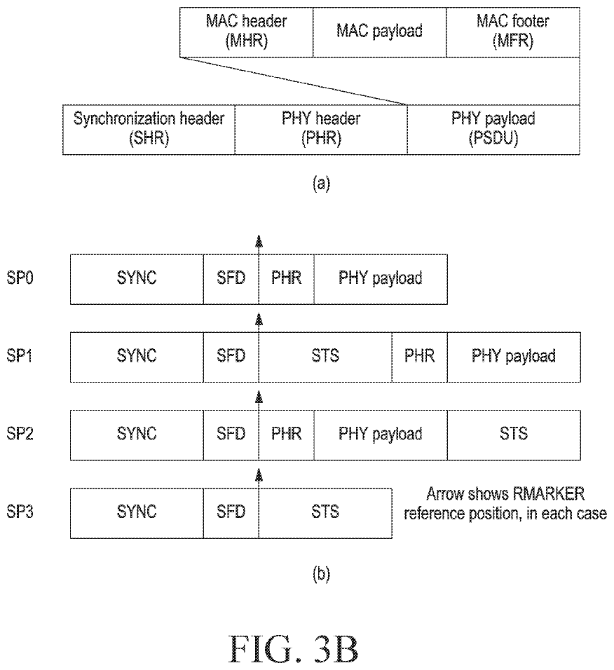

FIG. 3A illustrates a structure of a UWB MAC frame according to an embodiment of the disclosure.

In this disclosure, the UWB MAC frame may be simply referred to as a MAC frame or frame. As an embodiment, the UWB MAC frame may be used to transfer UWB-related data (e.g., UWB message, ranging message, control information, service data, application data, etc.).

Referring to FIG. 3A, the UWB MAC frame may include a MAC header (MHR), a MAC payload and/or a MAC footer (MFR).

### (1) MAC Header

The MAC header may include a Frame Control field, a Sequence Number field, a Destination Address field, a Source Address field, an Auxiliary Security Header field, and/or at least one Header IE field. According to an embodiment, some of the above-described fields may not be included in the MAC header, and additional field(s) may be further included in the MAC header.

In an embodiment, the Frame Control field may include a Frame type field, a Security Enabled field, a Frame Pending field, an ack request (AR) field, a PAN ID Compression field (PAN ID Present field), a Sequence Number Suppression field, an IE Present field, a Destination Addressing Mode field, a Frame Version field, and/or a Source Addressing Mode field. According to an embodiment, some of the above-described fields may not be included in the Frame Control field. Additional field(s) may be further included in the Frame Control field.

Each field is described below.

The Frame Type field may indicate the frame type. As an embodiment, the frame type may include a data type and/or a multipurpose type.

The Security Enabled field may indicate whether an Auxiliary Security Header field exists. The Auxiliary Security Header field may include information required for security processing.

The Frame Pending field may indicate whether the device transmitting the frame has more data for the recipient. In other words, the Frame Pending field may indicate whether there is a pending frame for the recipient.

The Ack Request (AR) field may indicate whether acknowledgment for frame reception is required from the recipient.

The PAN ID Compression field (PAN ID Present field) may indicate whether the PAN ID field exists.

The Sequence Number Suppression field may indicate whether the Sequence Number field exists. The Sequence Number field may indicate the sequence identifier for the frame.

The IE Present field may indicate whether the Header IE field and the Payload IE field are included in the frame.

The Destination Addressing Mode field may indicate whether the Destination Address field may include a short address (e.g., 16 bits) or an extended address (e.g., 64 bits). The Destination Address field may indicate the address of the recipient of the frame.

The Frame Version field may indicate the frame version. For example, the Frame Version field may be set to a value indicating IEEE std 802.15.4z-2020.

The Source Addressing Mode field may indicate whether the Source Address field exists, and if the Source Address field exists, whether the Source Address field includes a short address (e.g., 16 bits) or an extended address (e.g., 64 bits). The Source Address field may indicate the address of the originator of the frame.

### (2) MAC Payload

The MAC payload may include at least one Payload IE field. In an embodiment, the Payload IE field may include a Vendor Specific Nested IE.

### (3) MAC Footer

The MAC footer may include an FCS field. The FCS field may include a 16-bit CRC or a 32-bit CRC.

FIG. 3B illustrates a structure of a UWB PHY packet according to an embodiment of the disclosure.

Part (a) of FIG. 3B illustrates an example structure of a UWB PHY packet to which the STS packet configuration is not applied, and part (b) of FIG. 3B illustrates an example structure of a UWB PHY packet to which the STS packet configuration is applied. The UWB PHY packet may be referred to as a PHY packet, a PHY PDU (PPDU), or a frame.

Referring to part (a) of FIG. 3B, the PPDU may include a synchronization header (SHR), a PHY header (PHR), and a PHY payload (PSDU). The PSDU may include a MAC frame. As shown in FIG. 2, the MAC frame may include a MAC header (MHR), a MAC payload and/or a MAC footer (MFR). The synchronization header part may be referred to as a preamble, and the part including the PHY header and the PHY payload may be referred to as a data part.

The synchronization header may be used for synchronization for signal reception and may include a SYNC field and a start-of-frame delimiter (SFD).

The SYNC field may be a field including a plurality of preamble symbols used for synchronization between transmission/reception devices. The preamble symbol may be set through one of previously defined preamble codes.

The SFD field may be a field indicating the end of the SHR and the start of the data field.

The PHY header may provide information about the configuration of the PHY payload. For example, the PHY header may include information about the length of the PSDU, information indicating whether the current frame is an RFRAME (or Data Frame), and the like.

Meanwhile, the PHY layer of the UWB device may include an optional mode to provide a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for secure ranging.

Referring to part (b) of FIG. 3B, in the case of STS packet (SP) setting 0 (SP0), the STS field is not included in the PPDU (SP0 packet). In the case of SP setting 1 (SP1), the STS field is positioned immediately after the Start of Frame Delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the PPDU does not include the PHR, and PHY payload.

As illustrated in part (b) of FIG. 3B, each UWB PHY packet may include RMARKER for defining a reference time. RMARKER may be used to obtain the transmission time (transmission timestamp), reception time (reception timestamp) and/or time range of the ranging message (frame) in the UWB ranging procedure. For example, the UWB PHY packet may include an RMARKER within the preamble or at the end of the preamble.

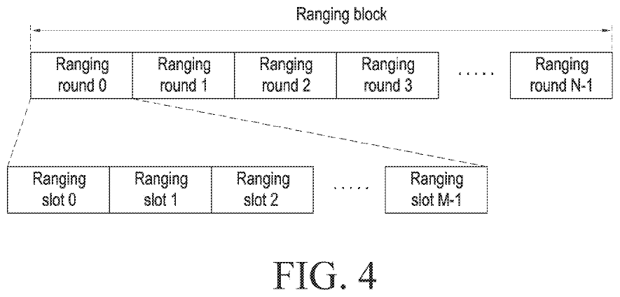

FIG. 4 illustrates an example of a structure of a ranging block and round used for UWB ranging according to an embodiment of the disclosure.

In this disclosure, the ranging block refers to a time period for ranging. The ranging round may be a period of sufficient duration to complete one entire range-measurement cycle in which a set of UWB devices participating in a ranging exchange involves. The ranging slot may be a sufficient period for transmission of at least one ranging frame (RFRAME) (e.g., ranging initiation/reply/final message, etc.).

As shown in FIG. 4, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds.

In the disclosure, a ranging block, a ranging round, and a ranging slot may be abbreviated as a block, a round, and a slot.

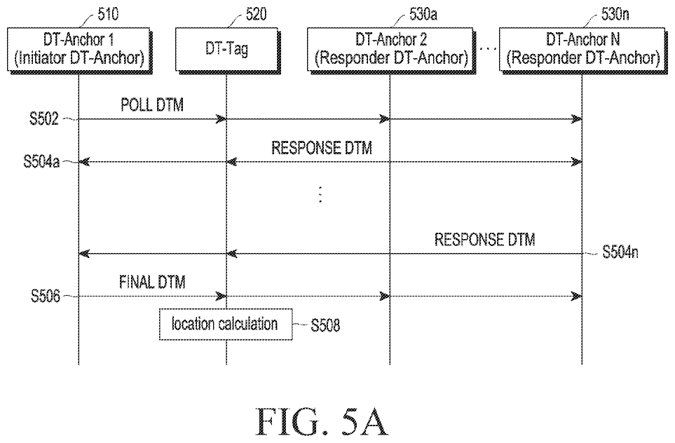

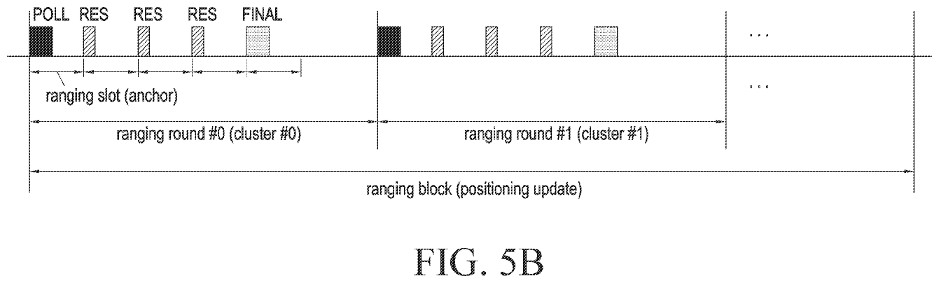

FIG. 5A illustrates a method for a UWB device to perform UWB ranging in a DL-TDoA scheme according to an embodiment of the disclosure.

The embodiment of FIG. 5A assumes that one initiator anchor (initiator DT-anchor) 510 and n responder anchors 530a . . . 530n operate as UWB anchors (DT-anchors). For example, as illustrated in FIG. 4, one initiator anchor and three responder anchors may act as UWB anchors. However, the embodiment is not limited thereto, and the number of UWB anchors, the number of initiator anchors and responder anchors included in the cluster may be varied according to embodiments.

In operation S502, the initiator anchor 510 may initiate a DL-TDoA round by transmitting or broadcasting the poll DTM received by the responder anchor in the cluster. The poll DTM may include scheduling information (e.g., ranging slot index) for each responder anchor to transmit the response DTM in the allocated ranging slot. The poll DTM may further include a transmission timestamp, which indicates the time when the poll DTM is transmitted. The poll DTM may further include the round index of the current ranging round in which the poll DTM is transmitted and the block index of the current ranging block. The poll DTM may further include location information about the UWB anchor transmitting the poll DTM.

In an embodiment, all responder anchors 530a . . . 530n may reference the scheduling information in the poll DTM, thereby knowing whether to transmit the response DTM and/or the slot (ranging slot index) used to transmit their response DTM.

In operations S504a . . . . S504n, all responder anchors 530a, . . . 530n receiving the poll DTM may respond to the initiator anchor 510 using the response DTM in the ranging slot allocated by the poll DTM. For example, each responder anchor 530a . . . , 530n may transmit or broadcast the response DTM in its ranging slot allocated by the poll DTM. Each response DTM may include response time information indicating the time between the time when the poll DTM is received and the time when the corresponding response DTM is transmitted. Each response DTM may include a transmission time (transmission timestamp) indicating the time when the response DTM is transmitted. Each response DTM may further include the round index of the current ranging round in which the corresponding response DTM is transmitted and the block index of the current ranging block. Each response DTM may further include location information about the UWB anchor transmitting the corresponding response DTM.

In operation S506, the initiator anchor 510 receiving the response DTMs may additionally transmit the final DTM to the responder anchors 530a . . . , 530n. For example, the initiator anchor 510 may transmit or broadcast the final DTM after receiving response DTMs from responder anchors 530a . . . , 530n. The final DTM may include a response time indicating the time between the time of receiving each response DTM and the time of transmitting the final DTM. In other words, the final DTM may include a list of response times, and the list may include a response time indicating the time between the time of receiving each response DTM and the time of transmitting the final DTM. The final DTM may include a transmission time (transmission timestamp) indicating the time when the final DTM is transmitted. The final DTM may further include the round index of the current ranging round in which the final DTM is transmitted and the block index of the current ranging block.

In operation S508, the tag device (DT-Tag) 520 may receive (or overhear) the poll DTM, response DTMs, obtain the information included in each DTM message and the reception time information (reception timestamp) indicating the time of receiving each DTM message and calculate the TDoA values using the obtained information. The tag device 520 may obtain (or estimate) its location based on the calculated TDoA values. For example, the tag device 520 may estimate its own location by calculating the relative distance to the anchor device through TDoA with several pairs of anchor devices. Thus, the tag device 520 may estimate its own location without exposing its own location.

Each DTM described above may be included in a MAC frame (e.g., the MAC frame of FIG. 3A), and transmitted through a UWB signal (or a PHY packet (e.g., the PHY packet of FIG. 3B)).

FIG. 5B illustrates an example of a ranging block structure for a downlink TDoA scheme according to an embodiment of the disclosure.

The ranging block structure of FIG. 5B may be an example of a ranging block structure for performing the ranging scheme of FIG. 5A.

Referring to FIG. 5B, the ranging block may include a plurality of ranging rounds.

As an embodiment, the ranging block may include a plurality of ranging rounds allocated for each of the plurality of clusters. For example, when n clusters are deployed, the ranging block may include a first ranging round allocated for a first cluster, a second ranging round allocated for a second cluster . . . and an nth ranging round allocated for an nth cluster. Although not shown in FIG. 5B, according to an embodiment, a plurality of ranging rounds may be allocated to one cluster, or one ranging round may be allocated to a plurality of clusters.

In an embodiment, a ranging round may include a plurality of ranging slots. The ranging round may include a plurality of ranging slots allocated for each ranging message transmitted by the anchor devices belonging to the cluster associated with the ranging round. For example, if the first cluster includes one initiator anchor and three responder anchors, the ranging round for the first cluster may include a first ranging slot (e.g., ranging slot index 0) allocated for transmission/reception of the Poll message of the Initiator anchor included in the first cluster, a second ranging slot allocated for transmission/reception of the response message of the first Responder anchor, a third ranging slot allocated for transmission/reception of the response message of the second Responder anchor, a fourth ranging slot allocated for transmission/reception of the response message of the third Responder anchor, and a fifth ranging slot allocated for transmission/reception of the final message of the Initiator anchor.

In this scheme, ranging slots may be allocated to the ranging round for each cluster.

Through the ranging block structure as in the embodiment of FIG. 5B, the anchor devices of each cluster may exchange ranging messages in one cycle through their own ranging rounds in one ranging block, and the UE (tag device) may receive these ranging messages and calculate its location. Such an operation may be repeated for each ranging block. Thus, the location of the UE may be updated in the period of the ranging block.

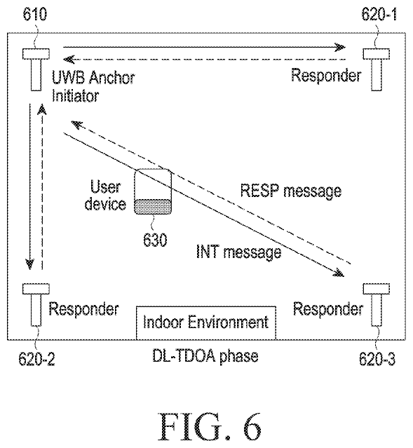

FIG. 6 illustrates a scenario for DL-TDoA-based positioning according to an embodiment of the disclosure.

DL-TDoA-based positioning may be real-time DL-TDoA-based positioning. DL-TDoA-based positioning may be DL-TDoA-based positioning in an indoor environment.

Referring to FIG. 6, at least four UWB anchors may be disposed for DL-TDoA-based positioning. For each ranging block, one UWB anchor 610 may operate as an initiator anchor, and other three or more UWB anchors 620-1, 620-2, and 620-3 may operate as responder anchors.

In the ranging block, UWB anchors may perform a ranging session. In the ranging session, the initiator anchor 610 may transmit an initiation message (poll DTM) to all of the responder anchors. Each responder anchor 620-1, 620-2, and 620-3 may transmit a response message (response DTM) to the initiator anchor. The response message may include a timestamp (reception timestamp) of the reception time of the initiation message and response time information. The response time information may indicate a time between the reception time of the initiation message and the transmission time of the response message.

The user device 630, which is a UWB tag, may simply listen to these messages. The user device 630 may calculate the TDoA of each responder anchor for the initiator anchor using the timestamps and response time information.

Using the calculated TDoA values and the previously provided locations of UWB anchors, the user device 630 may calculate the location (e.g., location coordinates) of the user device 630. For location calculation, at least one of a first scheme (a conventional scheme) using an LS estimation and a Kalman filter and a second scheme (a scheme according to the disclosure) using an RNN model may be used.

The user device (UWB tag) may estimate its current location or future location using TDoA data obtained from UWB signals for DL-TDoA.

Meanwhile, a least-square (LS) estimation-based location estimation algorithm (LS-based algorithm) may be used to estimate the future location using TDoA data. Further, a Kalman filter may be used after LS-based algorithms to enhance the accuracy of estimation.

However, due to non-line of sight (NLOS) or penetration losses. UWB signals are not always obtained by the user device. In particular, when a UWB signal is obtained from the initiator anchor, ranging based on TDoA may not be performed even when signals from all of the responder anchors are successfully obtained. LS estimation-based positioning suffers from such noise and multipath effects.

Meanwhile, IMU data has a high level of noise over time, makes noise as a non-Gaussian process. However, since the Kalman filter assumes noise following the Gaussian process, it may not accurately predict the direction using IMU data. Further, the recommended location value is diverged after several ranging rounds due to accumulation of errors. This causes the Kalman filter prediction unreliable and inaccurate when no TDoA data is obtained continuously.

Meanwhile, the mathematical model of noise distribution is difficult to calculate and may have very large time complexity in real-time applications.

Therefore, it is necessary to consider an algorithm that may reliably predict future location values (localization values) based on data previously obtained from the UWB signal and/or the IMU sensor.

Hereinafter, configurations of a system model and a user device using an algorithm (or method) for predicting a location using UWB data and/or IMU sensor data of the disclosure are described with reference to each drawing.

The algorithm of the disclosure may use an LSTM-based RNN model.

The algorithm of the disclosure may have high accuracy for location prediction compared to conventional LS estimation and Kalman filter-based algorithms.

The algorithm of the disclosure may use previous model predicted data as input data for predicting a location. For example, the algorithm of the disclosure may provide an algorithm that is robust to the lost UWB signal because previous model predicted data (data augmentation) may be used as input data for predicting location when external DL-TDoA data is not obtained.

The algorithm of the disclosure may use IMU data together with TDoA data as input data for location prediction. For example, the algorithm of the disclosure may use IMU data as input data for predicting a location when external DL-TDoA data is not obtained. In particular, when external DL-TDoA data is not obtained for a long period of time, the use of IMU data may greatly help enhance the accuracy of location prediction.

Since the algorithm of the disclosure maintains the features of the conventional DL-TDoA-based positioning algorithm, it may be applied to a multi-user environment in an efficient and scalable manner.

The algorithm of the disclosure may perform LS estimation-based location prediction using real-time DL-TDoA data in the user device in parallel to RNN-based location prediction and fine-tune the trained model based on comparison of the prediction results, thus optimizing the RNN model without sacrificing the efficiency of the RNN model.

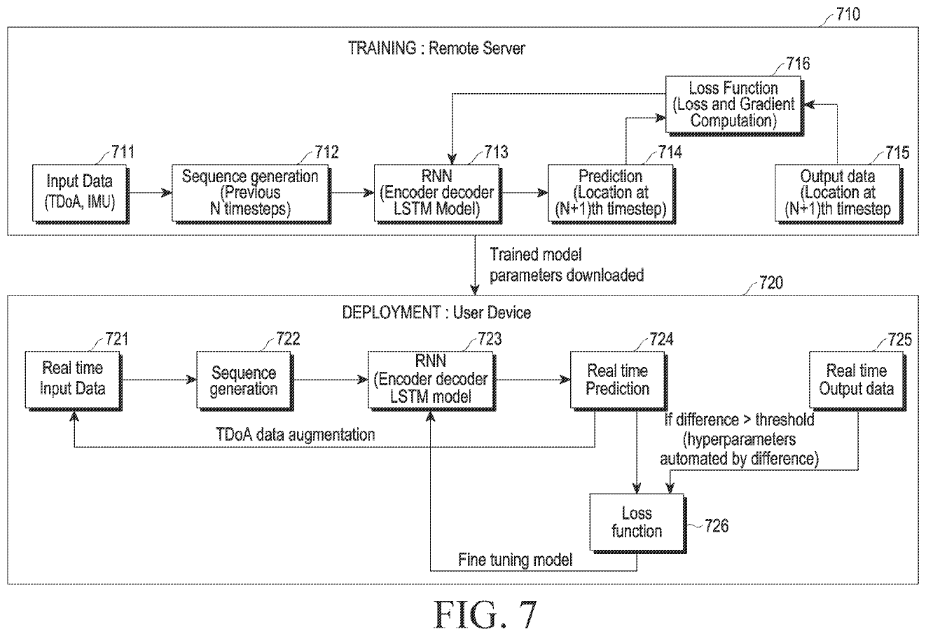

FIG. 7 illustrates a system model for predicting location according to an embodiment of the disclosure.

In the embodiment of FIG. 7, for convenience of description, it is assumed that a training procedure is performed on a remote server 710, and a test procedure is performed on a user device. However, embodiments of the disclosure are not limited thereto. For example, if the user device 720 is a device having high computing power, the training procedure may also be performed in the user device.

First, a training procedure 710 in a remote server is described with reference to FIG. 7. In the disclosure, the training procedure may be a procedure for training a model using pre-collected training data. In the disclosure, the model may be a recurrent neural network (RNN)-based model. As an embodiment, the RNN-based model may be a long short-term memory models (LSTM)-based RNN model. LSTM is a type of RNN, and historical data (e.g., data from previous timesteps) may be used to predict the output of future timesteps.

In the training procedure, in operation 711, the remote server may collect input data. As an embodiment, the input data may include TDoA data (TDoA data) obtained by performing UWB DL-TDoA and/or IMU data (IMU sensor data) obtained by the IMU sensor. In various experimental and real-life scenarios, a large amount of input data may be collected as training data.

In operation 712, the remote server may generate sequences from the input data. As an embodiment, the remote server may generate sequences from input data using a preset sequence generation algorithm. One sequence may be a set of TDoA data and/or IMU data of previous timesteps corresponding to the number designated by the number of input timesteps (Number_of_Input_Timesteps) parameter. The entire collected input data may be arranged in sequences.

In operation 713, the remote server may receive a sequence input using the RNN model and may output a sequence. For example, the remote server may receive sequence data as a sequence input and give prediction data as a sequence output at the next timestep (N+1 timestep). As an embodiment, the prediction data may include predicted TDoA data and/or predicted location data (e.g., location coordinates) at the next timestep N+1.

As an embodiment, the RNN model may include long short-term memory (LSTM)-based encoder-decoder stages. The encoder stage may include multiple LSTM cells that read the input sequence and summarize information into internal memory states. The decoder stage may include multiple LSTM cells for reading memory state information about the encoder and generating an output sequence.

Table 1 below shows an example of the architecture of the RNN model used for location prediction.

TABLE 1

| LAYER | NUMBER OF UNITS | ACTIVATION FUNCTION |
|---|---|---|
| Input | Variable * | — |
| LSTM | 128 | — |
| LSTM | 128 | — |
| LSTM | 128 | — |
| LSTM | 128 | — |
| Fully Connected | 2 | ReLU |
| Regression | 2 | — |

Table 2 below shows an example of network parameters of the RNN model used for location prediction.

TABLE 2

| | |
|---|---|
| Weights Initializer | Random |
| Solver | Adam |
| Number of Training Epochs | 100 |
| Batch Size | 10 |
| Number of Input Timesteps | 16 |
| Number of Output Timesteps | 1 |
| Shuffle | Every Epoch |
| Initial Learning Rate | 0.0001 |
| Learning Rate Drop Factor | 0.5 |
| Learning Rate Drop Period | 20 Epochs |
| L2 Regularization | 0.00001 |
| Loss Function | Mean Squared Error |

In operation 714, the remote server may obtain a prediction value (e.g., predicted location coordinates) for a location from the prediction data output from the RNN model, and may transmit the obtained prediction value to the next step.

In operation 715, the remote server may obtain an actual value (ground truth location value) corresponding to the prediction value and transmit the obtained actual value to the next step. For example, the remote server may transmit an actual value (e.g., actual location coordinates) for the location at the next timestep (N+1 timestep) to the next step.

In operation 716, the remote server may compare the prediction value with the actual value to generate (or calculate) a loss function based on an error between the prediction value and the actual value. The loss function may be backpropagated through the layers of the RNN in order to train the RNN model. Through this training process, parameters of the RNN model may be updated in a direction of reducing errors. The parameters for the trained model may be downloaded by the user device and used for a test procedure in the user device.

Hereinafter, a test procedure 720 in the user device is described with reference to FIG. 7. In the disclosure, the test procedure may be a procedure for testing the model trained using actual data (e.g., real-time data).

In the test procedure, in operation 721, the user device may collect real-time input data. As an embodiment, the real-time input data may include TDoA data (TDoA data) obtained by performing UWB DL-TDoA, IMU data (IMU sensor data) obtained by an IMU sensor, and/or location data (e.g., location coordinates). For example, the input data may include TDoA data (TDoA data) obtained by performing UWB DL-TDoA for a preset number of previous timesteps, IMU data (IMU sensor data) obtained by the IMU sensor, and/or location data (e.g., location coordinates).

In operation 722, the user device may generate sequences from the input data (real-time input data). As an embodiment, the user device may generate sequences from the input data using a preset sequence generation algorithm. One sequence may be a set of TDoA data and/or IMU data of previous timesteps corresponding to the number designated by the number of input timesteps (Number_of_Input_Timesteps) parameter.

In operation 723, the user device may receive a sequence input using the RNN model and may output a sequence. For example, the user device may receive sequence data as a sequence input and give prediction data as a sequence output at the next timestep (N+1 timestep). As an embodiment, the prediction data may include predicted TDoA data and/or predicted location data (e.g., location coordinates) at the next timestep N+1. As such, the method for the disclosure may be used to predict TDoA values or future location value or TDoA values generated through the DL-TDoA procedure.

In operation 724, the user device may obtain a prediction value (e.g., predicted location coordinates) for a location from the prediction data output from the RNN model, and may transmit the obtained prediction value to the next step.

Meanwhile, TDoA data may not be obtained or TDoA value(s) may be missing due to, e.g., reception signal failure or blockage. If TDoA data is not obtained or TDoA value(s) is missing, the user device may use augmented data as input data. In this case, the user device may generate sequence data using the augmented data.

As an embodiment, the user device may use the location value predicted at the previous timestep T as augmented data (augmented location data) for generating an input at the next timestep T+1. To that end, as illustrated, the data of operation 724 may be provided as operation 721. (TDoA data augmentation).

As an embodiment, the user device may use the predicted (model-predicted) TDoA value(s) at the previous timestep T as augmented data (augmented TDoA data) to generate an input at the next timestep T+1. To that end, as illustrated, the data of operation 724 may be provided as operation 721. (TDoA data augmentation).

As an embodiment, the user device may use the location value predicted at the previous timestep T and the predicted (model-predicted) TDoA value(s) as augmented data to generate an input at the next timestep T+1. To that end, as illustrated, the data of operation 724 may be provided as operation 721. (TDoA data augmentation).

When using the TDoA data augmentation method, the user device may continue to predict location values even if TDoA data is not obtained at a specific time. This creates an algorithm that is robust to UWB signal reception failures.

In operation 725, the user device may identify a prediction value (second prediction value) corresponding to the RNN-based prediction value (first prediction value), and may transfer the identified second prediction value to the next step. For example, when a UWB signal for DL-TDoA is obtained or the TDoA value(s) is not missing, the user device may use the TDoA data obtained from UWB signals to obtain least-square (LS) estimation-based location value (location coordinates at the N+1 timestep) using the TDoA data obtained from the UWB signals and transfer the corresponding location value, as the second prediction value, to the next step.

In operation 726, the user device may compare the RNN-based prediction value (first prediction value) and the LS estimation-based prediction value (second prediction value), and fine-tune the model trained in real-time based on the comparison result. For example, the user device may compare the first prediction value with the second prediction value and determine whether to generate (or calculate) a loss function based on a difference between the first prediction value and the second prediction value. For example, when the difference between the first prediction value and the second prediction value is larger than a preset threshold, the user device may determine to calculate the loss function. When the difference between the first prediction value and the second prediction value is not larger than the preset threshold, the user device may determine not to calculate the loss function. The calculated loss function may be backpropagated through the layers of the RNN in order to fine-tune the RNN model.

Through the fine-tuning process for the trained model, the parameters of the RNN model may be adjusted in real-time in the direction of reducing errors. As such, the method of the disclosure may perform RNN-based prediction in parallel to LS estimation-based prediction in real-time. This enables real-time parallel model fine-tuning, allowing the RNN model to be optimized without sacrificing the efficiency of the RNN model.

FIG. 8 illustrates a configuration of a user device for predicting location according to an embodiment of the disclosure.

The user device 800 of FIG. 8 may be an example of a user device performing the test procedure 720 of FIG. 7.

Referring to FIG. 8, a user device 800 may include an IMU sensor 810, a sensor data measurement unit 820, a UWB antenna 830, a communication unit 840, a machine learning unit 850, a processor 860, a central controller 870 and/or a storage unit 880. The processor 860 may include a TDoA generator 861, a sequence generator 862, an LS generator 863, and/or a threshold generator 864.

According to an embodiment, some of the above-described components may be omitted or additional components may be further included. According to an embodiment, two or more of the above-described components may be merged into one component. According to an embodiment, all or some of the above-described components may be implemented by at least one processor (or controller). For example, the components except for the IMU sensor 810, the UWB antenna 820, and the storage unit 880 may be implemented by at least one processor (or controller).

The IMU sensor 810 may sense a surrounding environment and provide sensing data. For example, the IMU sensor 810 may provide sensor data measurements (e.g., accelerometer measurements and/or gyroscope measurements). The IMU sensor 810 may transfer sensor data measurements (IMU sensor data) to the sensor data measurement unit 820. The sensor data measurement unit 820 may transfer the IMU sensor data to the sequence generator 862.

The UWB antenna 820 may transmit/receive a UWB signal. For example, the UWB antenna 820 may receive at least one UWB signal (or UWB message DTM) for DL-TDoA.

The UWB antenna 820 may collect timestamps (e.g., transmission timestamps and/or reception timestamps) and response time information from UWB signals exchanged between UWB anchors. The UWB antenna 820 may transfer the collected timestamps to the communication unit 840. The communication unit 840 may transfer the timestamps to the TDoA generator 861.

The TDoA generator 861 may calculate (or generate) TDoA values using the received timestamps. The TDoA values may include a TDoA value between an initiator anchor and each responder anchor. The TDoA generator 861 may transfer the TDoA values to the sequence generator 862.

If there is no missing TDoA value(s), the TDoA generator 861 may transfer the TDoA values to the LS generator 861. For example, when TDoA values between the initiator anchor and all of the responder anchors are obtained, the sequence generator 862 may transfer a message to the central controller 870.

If there is a missing TDoA value(s) (when some or all TDoA values are missing due to, e.g., signal reception failure), the sequence generator 862 may transfer a message to the central controller 870. For example, if the TDoA value between the initiator anchor and a specific response anchor is missing, the sequence generator 862 may transfer a message to the central controller 870. In this case, the central controller 870 may transfer a message to the storage unit 880. The message may be a message (Send augmented TDoA) indicating transmission of the augmented TDoA values. The storage unit 880 may transfer the augmented TDoA values stored in the storage unit 880 to the sequence generator 862.

If there is no missing TDoA value(s), the sequence generator 862 may transfer the generated sequence data to the machine learning unit 850.

The machine learning unit 850 may download parameters for a trained RNN model (e.g., the RNN model trained according to the training procedure 710 of FIG. 7) from the remote server before starting the entire process.

The machine learning unit 850 may output prediction data (model output) based on the sequence data. As an embodiment, the prediction data may include predicted TDoA data and/or predicted location data (e.g., location coordinates) at the next timestep. The machine learning unit 850 may transfer the predicted location value (first prediction value) to the threshold generator 864.

The LS generator 863 may output a predicted location value (LS estimation result) using an LS estimation-based algorithm based on the TDoA values. In an embodiment, when there is no missing TDoA value, the LS generator 863 may output the predicted location value (LS estimation result) using the LS estimation-based algorithm based on the TDoA values. The LS generator 863 may transfer the predicted location value (second prediction value) to the threshold generator 864.

The threshold generator 864 may calculate a difference between the RNN-based prediction (first prediction value) and the LS-based prediction (second prediction value). If the difference is larger than a preset threshold, the threshold generator 864 may transfer a message to the central controller 870. The central controller 870 may obtain the message and transfer the message to the LS generator 863. The LS generator 863 may transfer the LS predicted location value (second prediction value) as a “ground truth” output to the machine learning unit 850. The machine learning unit 850 may perform fine-tuning on the model using the second prediction value as a ground truth value. For example, the machine learning unit 850 may compare the first prediction value and the second prediction value (ground truth value), calculate a loss function based on an error between the first prediction value and the second prediction value, and backpropagate the calculated loss function to the RNN model for fine-tuning the model.

Hereinafter, a result of performance evaluation of the location estimation method of the disclosure is described.

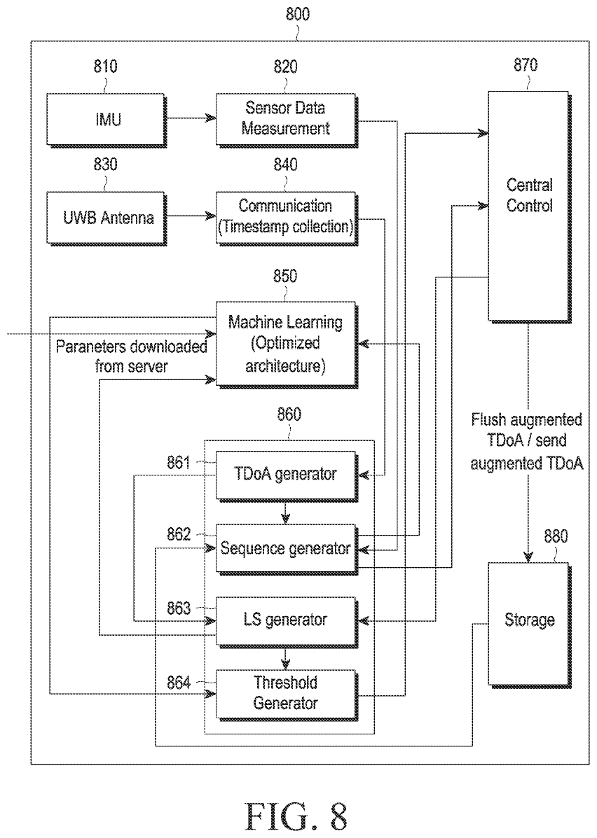

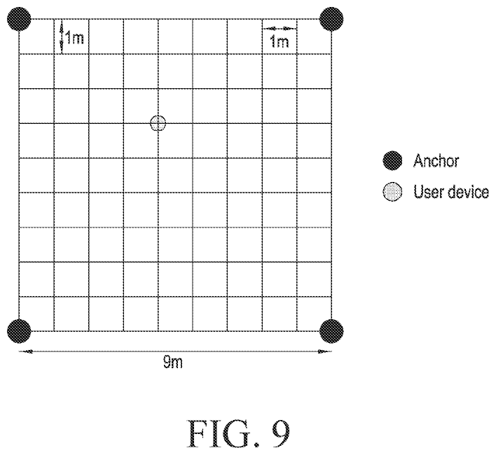

For performance evaluation, the test environment of FIG. 9 is considered.

FIG. 9 illustrates a test environment for evaluating the performance of a location estimation method according to an embodiment of the disclosure.

Referring to FIG. 9, four UWB anchors may be disposed at vertices, respectively, of a square, and the user device may be located in a cluster including the UWB anchors.

Further, for performance evaluation, the following four cases are considered as inputs (input data).
Case 1: TDoA data (estimated/augmented) for all of the responder anchors for 16 previous timesteps
Case 2: TDoA data (established/augmented) and IMU sensor data for all of the responder anchors for 16 previous timesteps
Case 3: TDoA data (established/augmented) and location values (location data) for all of the responder anchors for 16 previous timesteps
Case 4: TDoA data (established/augmented), location values (location data), and IMU data for all of responder anchors for 16 previous timesteps

As described above, each case is configured differently depending on whether TDoA data previous location values, and IMU sensor data are included/excluded as input. Further, the TDoA data and previous location data may be obtained from external data or may be obtained by data augmentation from the RNN model. Meanwhile, in each case, the output is location values (location coordinates (x and y coordinates)) for the next timestep.

Meanwhile, the baseline algorithm used for performance comparison with the location estimation method of the disclosure may be an LS estimation algorithm and a conventional algorithm using a Kalman filter.

For each of the four cases for performance evaluation, the following three scenarios may be considered.
Scenario 1 (first scenario): A scenario in which all required UWB signals are always obtained, and TDoA values are always obtained without missing. In this scenario, the augmented TDoA values predicted by the RNN model need not be used.
Scenario 2 (second scenario): A scenario in which UWB data for a straight line trajectory is missing for 3 seconds. In this scenario, TDoA data for 15 (=3 s/0.2 s) consecutive blocks are missing. Since there is no externally obtained location data, IMU sensor data and/or location predicted at timestep T is used to generate an input at timestep T+2.
Scenario 3 (third scenario): A scenario in which UWB data in the corner of trajectory for 70 (=14 s/0.2 s) consecutive blocks is missing, similar to scenario 2.

Hereinafter, performance evaluation results in each scenario are described with reference to each drawing.

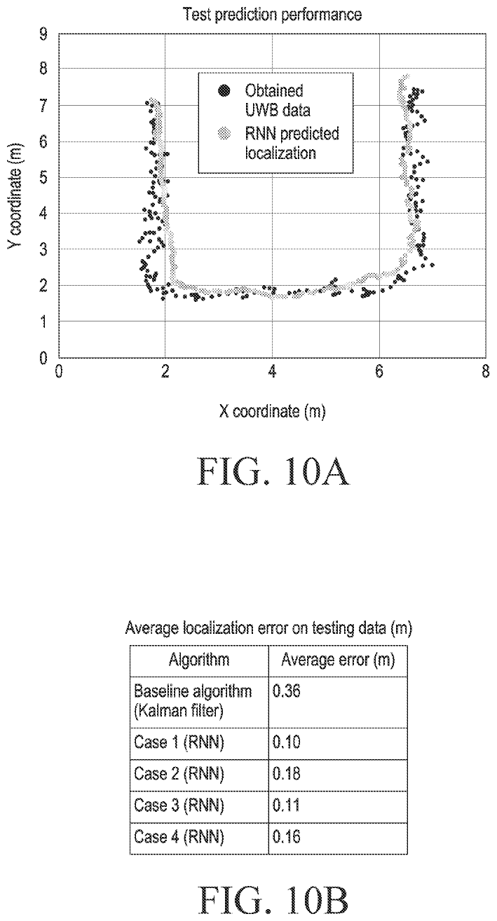

FIGS. 10A and 10B illustrate a performance evaluation result in a first scenario according to an embodiment of the disclosure.

FIG. 10A shows test prediction performance in the first scenario, and FIG. 10B shows an average location error for test data in the first scenario.

Referring to FIGS. 10A and 10B, the location estimation method (RNN-based method) of the disclosure in all of the four cases shows higher performance than the conventional method (LS estimation and Kalman filter-based method). On the other hand, the first scenario in which all UWB signals are obtained shows an increase in average error in the cases where IMU data is included (cases 2 and 4). This is due to the high noise level of IMU data.

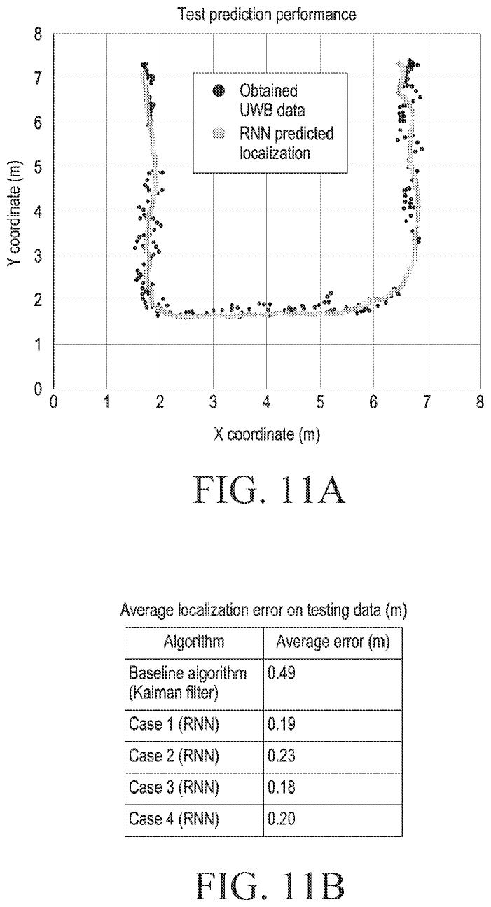

FIGS. 11A and 11B illustrate a performance evaluation result in a second scenario according to an embodiment of the disclosure.

FIG. 11A illustrates test prediction performance in the second scenario, and FIG. 11B illustrates an average location error for test data in the second scenario.

Referring to FIGS. 11A and 11B, the second scenario shows similar performance evaluation to that of the first scenario. For example, in the second scenario, the location estimation method (RNN-based method) of the disclosure shows higher performance than the conventional method (LS estimation and Kalman filter-based method) in all of the four cases. Meanwhile, the second scenario shows an increase in average error in the cases where IMU data is included (cases 2 and 4). This is due to the high noise level of IMU data.

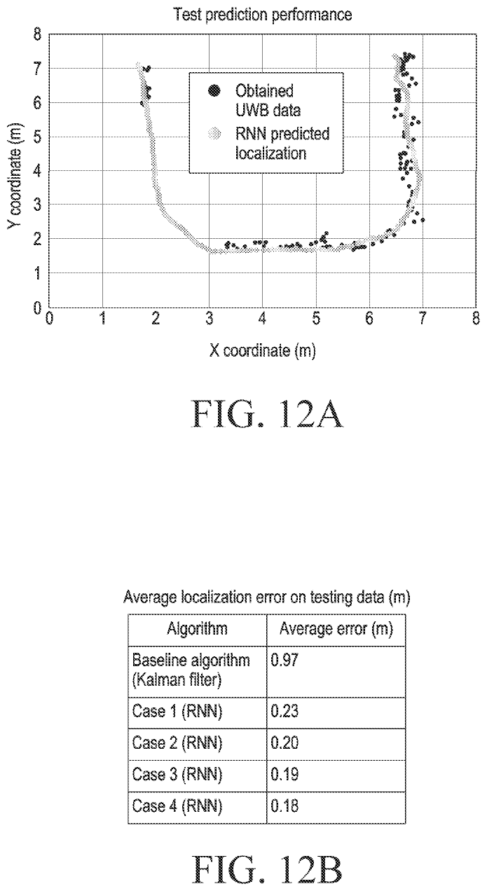

FIGS. 12A and 12B illustrate a performance evaluation result in a third scenario according to an embodiment of the disclosure.

FIG. 12A illustrates test prediction performance in the second scenario, and FIG. 12B illustrates an average location error for test data in the second scenario.

Referring to FIGS. 12A and 12B, it may be identified that in the third scenario, long-term missing of UWB signals relies on the TDoA values augmented using the previous locations model-predicted and, at this time, the IMU data helps enhance performance and reduce the average location error. The IMU enhancing effect may become more important as the time when UWB is not available increases.

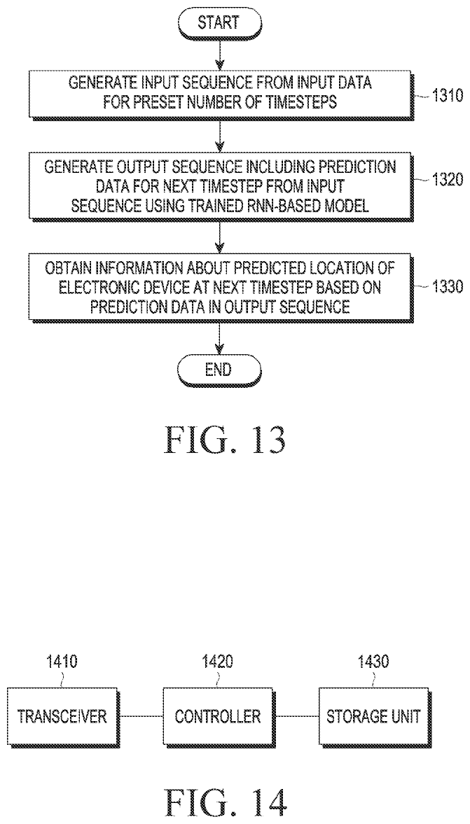

FIG. 13 illustrates a method for predicting location using a trained model by an electronic device according to an embodiment of the disclosure.

In an embodiment of FIG. 13, the electronic device may be a user device (e.g., the user device 800 of FIG. 8).

Referring to FIG. 13, the electronic device may generate an input sequence from input data for a preset number of timesteps (1310). According to an embodiment, the input data may include UWB DL-TDoA data.

The electronic device may generate an output sequence including prediction data for a next timestep from the input sequence using the trained RNN-based model (1320).

The electronic device may obtain information about the predicted location of the electronic device at the next timestep based on the prediction data in the output sequence (1330).

As an embodiment, the input data may further include at least one of IMU sensor data or location data.

In an embodiment, when at least one of the UWB signals for DL-TDoA received from the UWB anchors is missing, the UWB DL-TDoA data may include the augmented UWB DL-TDoA data, and the augmented UWB DL-TDoA data may include UWB DL-TDoA values predicted through the RNN-based model.

As an embodiment, when at least one of the UWB signals for DL-TDoA received from UWB anchors is not missing, the user device may obtain information about the predicted second location of the electronic device at the next timestep from the UWB DL-TDoA data using a least square (LS)-based location estimation method.

As an embodiment, the user device may identify a difference between the predicted location and the predicted second location based on the information about the predicted location and the predicted second location, and determine whether to perform fine-tuning on the trained RNN-based model based on the difference.

As an embodiment, the user device may determine to perform fine-tuning on the trained RNN-based model when the difference is larger than a preset threshold, and determine not to perform fine-tuning on the trained RNN-based model when the difference is not larger than the threshold.

As an embodiment, when determining that the user device performs fine-tuning on the trained RNN-based model, the user device may calculate a loss function based on the difference between the predicted location and the predicted second location, and backpropagate the loss function for fine-tuning on the trained RNN-based model.

As an embodiment, the trained RNN-based model is an LSTM-based RNN model, and the LSTM-based RNN model may include an LSTM-based encoder stage and decoder stage.

As an embodiment, the UWB DL-TDoA data may include TDoA values between an initiator anchor and each of a plurality of responder anchors.

FIG. 14 is a view illustrating a structure of an electronic device according to an embodiment of the disclosure.

In the embodiment of FIG. 14, the electronic device may be a user device (e.g., the user device 800 of FIG. 8).

Referring to FIG. 14, the electronic device may include a transceiver 1410, a controller 1420, and a storage unit 1430. In the present disclosure, the controller may be defined as a circuit, an application-specific integrated circuit, or at least one processor.

The transceiver 1410 may transmit and receive signals to/from other network entities. The transceiver 1410 may transmit/receive data for commissioning.

The controller 1420 may control the overall operation of the electronic device according to an embodiment. For example, the controller 1420 may control inter-block signal flow to perform the operations according to the above-described flowchart. Specifically, the controller 1420 may control the operations of the electronic device described above with reference to FIGS. 1 to 13.

The storage unit 1430 may store at least one of information transmitted/received via the transceiver 1410 and information generated via the controller 1420. For example, the storage unit 1430 may store information and data necessary for predicting location described above with reference to FIGS. 1 to 13.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method by an electronic device using ultra-wideband (UWB) communication, the method comprising:
generating an input sequence from input data for a preset number of timesteps, the input data including UWB downlink time difference of arrival (DL-TDoA) data;
generating an output sequence including prediction data for a next timestep from the input sequence using a trained recurrent neural network (RNN)-based model; and
obtaining information about a predicted location of the electronic device at the next timestep based on the prediction data in the output sequence.

2. The method of claim 1, wherein the input data further includes at least one of IMU sensor data or location data.

3. The method of claim 1, wherein when at least one of UWB signals for DL-TDoA received from UWB anchors is missing, the UWB DL-TDoA data includes augmented UWB DL-TDoA data, and the augmented UWB DL-TDoA data includes UWB DL-TDoA values predicted through the RNN-based model.

4. The method of claim 1, further comprising, when at least one of UWB signals for DL-TDoA received from UWB anchors is not missing, obtaining information about a predicted second location of the electronic device at the next timestep from the UWB DL-TDoA data using a least square (LS)-based location estimation method.

5. The method of claim 3, further comprising:
identifying a difference between the predicted location and the predicted second location based on the information about the predicted location and the information about the predicted second location; and
determining whether to perform fine tuning on the trained RNN-based model based on the difference.

6. The method of claim 5, wherein determining whether to perform the fine tuning on the trained RNN-based model based on the difference further includes:
determining to perform the fine-tuning on the trained RNN-based model when the difference is larger than a preset threshold; and
determining not to perform the fine-tuning on the trained RNN-based model when the difference is not larger than the threshold.

7. The method of claim 6, further comprising:
when determining to perform the fine-tuning on the trained RNN-based model, calculating a loss function based on the difference between the predicted location and the predicted second location; and
backpropagating the loss function for the fine-tuning on the trained RNN-based model.

8. The method of claim 1, wherein the trained RNN-based model includes an LSTM-based RNN model, and the LSTM-based RNN model includes an LSTM-based encoder step and decoder step, and
wherein the UWB DL-TDoA data includes TDoA values between an initiator anchor and each of a plurality of responder anchors.

9. An electronic device using ultra-wideband (UWB) communication, comprising:
a transceiver; and
a controller connected to the transceiver, wherein the controller is configured to:
generate an input sequence from input data for a preset number of timesteps, the input data including UWB downlink time difference of arrival (DL-TDoA) data;
generate an output sequence including prediction data for a next timestep from the input sequence using a trained recurrent neural network (RNN)-based model; and
obtain information about a predicted location of the electronic device at the next timestep based on the prediction data in the output sequence.

10. The electronic device of claim 9, wherein when at least one of UWB signals for DL-TDoA received from UWB anchors is missing, the UWB DL-TDoA data includes augmented UWB DL-TDoA data, and the augmented UWB DL-TDoA data includes UWB DL-TDoA values predicted through the RNN-based model.

11. The electronic device of claim 9, wherein the controller is further configured to, when at least one of UWB signals for DL-TDoA received from UWB anchors is not missing, obtain information about a predicted second location of the electronic device at the next timestep from the UWB DL-TDoA data using a least square (LS)-based location estimation method.

12. The electronic device of claim 11, wherein the controller is further configured to:
identify a difference between the predicted location and the predicted second location based on the information about the predicted location and the information about the predicted second location; and
determine whether to perform fine tuning on the trained RNN-based model based on the difference.

13. The electronic device of claim 12, wherein the controller is further configured to:
determine to perform the fine-tuning on the trained RNN-based model when the difference is larger than a preset threshold; and
determine not to perform the fine-tuning on the trained RNN-based model when the difference is not larger than the threshold.

14. The electronic device of claim 13, wherein the controller is further configured to:
when determining to perform the fine-tuning on the trained RNN-based model, calculate a loss function based on the difference between the predicted location and the predicted second location; and
backpropagate the loss function for the fine-tuning on the trained RNN-based model.

15. The electronic device of claim 9, wherein the trained RNN-based model includes an LSTM-based RNN model, and the LSTM-based RNN model includes an LSTM-based encoder step and decoder step, and
wherein the UWB DL-TDoA data includes TDoA values between an initiator anchor and each of a plurality of responder anchors.
